(19) United States
(12) Patent Application Publication
(10) Pub. No.: US 2011/0103632 A1
(43) Pub. Date: May 5, 2011

(54) INTEGRATED ACOUSTIC HORN AND LEAD FRAME

(75) Inventors: Timothy Leclair, Longmont, CO (US); Atul Goel, Fort Collins, CO (US)

(73) Assignee: Avago Technologies Wireless IP (Singapore) Pte. Ltd., Singapore (SG)

(21) Appl. No.: 12/609,176

(22) Filed: Oct. 30, 2009

(51) Int. Cl. H04R 1/20

(52) U.S. Cl. 381/340

(57) ABSTRACT

A device for manipulating acoustic signals includes a transducer die and a horn. The transducer die is attached to a lead frame and configured to convert between electrical energy and the acoustic signals, the transducer die having a transducer membrane. The horn is integrally connected with the lead frame, the horn extending from the lead frame and having a throat positioned adjacent to the transducer membrane and a mouth opening at an opposite end of the horn from the throat.

### BACKGROUND

Transducers incorporated in various electronic devices include semiconductor integrated circuits for converting electrical signals into acoustic signals (e.g., acoustic waves) and/or acoustic signals into electrical signals. The conversion is useful in numerous applications, such as signal filtering, signal isolation, sensing, mechanical actuation, etc.

In order to generate ultrasonic acoustic signals, in particular, the transducers must be quite small. For example, micro electro-mechanical system (MEMS) transducers may be used as ultrasonic transducers. MEMS transducers are typically more efficient than traditional transducers. However, due to their small size, MEMS transducers have lower effective output power, lower sensitivity and/or broader (less focused) radiation patterns. Further, such transducers may be included in semiconductor packages, including lead frames to provide easier connections with other circuits.

### SUMMARY

In a representative embodiment, a device for manipulating acoustic signals includes a transducer die attached to a lead frame and configured to convert between electrical energy and the acoustic signals, the transducer die having a transducer membrane. The device further includes a horn integrally connected with the lead frame, the horn extending from the lead frame and having a throat positioned adjacent to the transducer membrane and a mouth opening at an opposite end of the horn from the throat.

In another representative embodiment, a device includes a lead frame, an acoustic horn and a transducer die. The acoustic horn includes a base portion integrated with the lead frame and a protruding portion extending from the lead frame, the acoustic horn defining a first aperture corresponding to a horn throat and a second aperture corresponding to a horn mouth. The transducer die is positioned on the lead frame adjacent to the first aperture of the acoustic horn, and configured to convert between electrical energy and acoustic signals. The acoustic horn adjusts a radiation pattern of the acoustic signals.

In another representative embodiment, a packaged semiconductor device includes a lead frame defining an aperture, a transfer molded acoustic horn, a lid and a transducer die. The transfer molded acoustic horn includes a base portion integrated with the lead frame and a protruding portion extending from the lead frame, a throat of the acoustic horn being substantially aligned with the aperture of the lead frame. The lid is connected to the integrated acoustic horn and lead frame to form a cavity. The transducer die is positioned in the cavity on the lead frame, the transducer die including a MEMS transducer configured to convert between electrical energy and acoustic signals, the MEMS transducer having a membrane and a back-etched portion substantially aligned with the aperture of the lead frame and the throat of the acoustic horn.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 is a cross-sectional diagram illustrating an integrated lead frame and acoustic horn packaging structure for a transducer, according to a representative embodiment.

FIGS. 2A through 2D are perspective views illustrating integrated lead frame and acoustic horn packaging, according to a representative embodiment.

FIG. 3 is a flow diagram illustrating a process for fabricating an integrated lead and acoustic horn package, according to a representative embodiment.

FIG. 4 is a perspective view illustrating integrated lead frame and acoustic horn packaging during the fabrication process, according to a representative embodiment.

### DETAILED DESCRIPTION

In the following detailed description, for purposes of explanation and not limitation, representative embodiments disclosing specific details are set forth in order to provide a thorough understanding of the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatuses and methods may be omitted so as to not obscure the description of the representative embodiments. Such methods and apparatuses are clearly within the scope of the present teachings.

Generally, horns may be used to amplify acoustic signals, making them louder, as indicated by the incorporation of horns in various musical instruments and early hearing aids, for example. Horns may also be used to manipulate radiation patterns of acoustic emitters, generally referred to as beam forming or beam shaping, thus affecting dispersion of the acoustic signals. In addition, horns may provide impedance matching, rendering the acoustic emitter more compatible with the medium through which the acoustic signals travel. The acoustic emitters may include, for example, ultrasonic transducers and micro electro-mechanical system (MEMS) transducers. As discussed below, various embodiments make use of transfer molded lead frame semiconductor packaging technology to provide an integrated horn and lead frame, which protects the transducer (e.g., MEMS microchip) as well as amplifies the acoustic signals, manipulates the associated radiation pattern and/or provide impedance matching, for more efficient implementation.

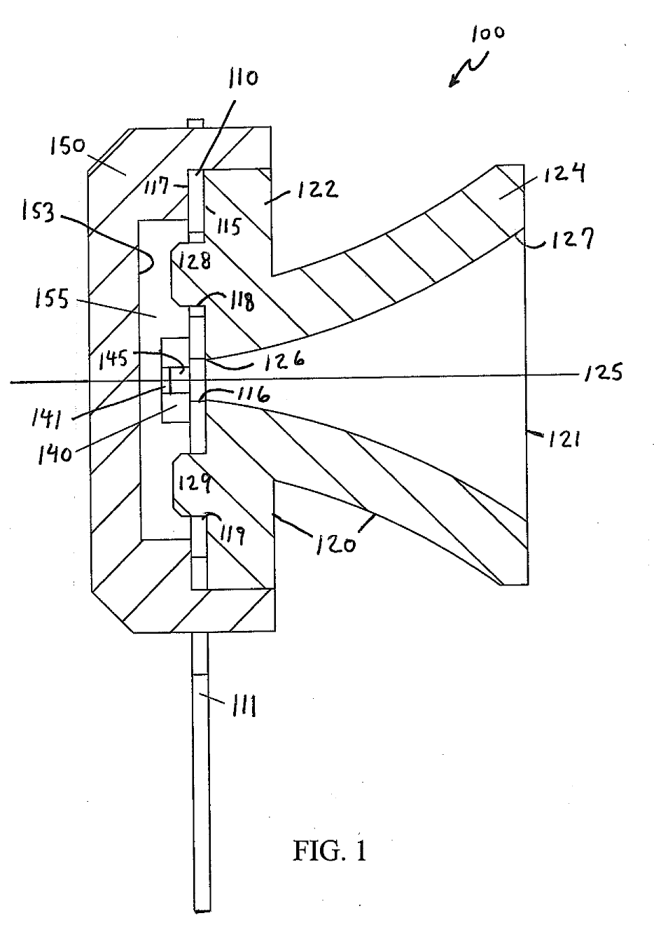

FIG. 1 is a cross-sectional diagram illustrating a semiconductor lead frame package, including an integrated lead frame and acoustic horn assembly for an acoustic transducer, such as an ultrasonic or MEMS transducer integrated circuit, according to a representative embodiment.

As shown in FIG. 1, lead frame package 100 includes lead frame 110 integrally attached to acoustic horn 120. The acoustic horn 120 includes a base portion 122 that abuts a first side (e.g., bottom side) 115 of the lead frame 110 and a protruding portion 124 that extends from the base portion 122 along a center axis 125 in a direction substantially perpendicular to the lead frame 110. In a representative embodiment, the acoustic horn 120 is formed from plastic transfer molded to the lead frame 110, discussed below.

In the depicted embodiment, the protruding portion 124 has a generally hyperbolic or exponential cross-sectional shape, such that an inner dimension of the acoustic horn 120 extends outwardly from an inner aperture or throat 126 to a flared outer aperture or mouth 127. For example, the throat 126 may be circular with a diameter of about 2 mm and the mouth 127 may likewise be circular with a diameter of about 8 mm. However, the sizes and shapes of the acoustic horn 120 and corresponding throat 126 and mouth 127, as well as the respective configurations of the base portion 122 and the protruding portion 124, may vary to provide unique benefits for any particular situation or to meet application specific design requirements of various implementations, as would be apparent to one skilled in the art. For example, the cross-sectional shape of the protruding portion 124 may be substantially conical, tubular, rectangular or trapezoidal, without departing from the scope of the present teachings.

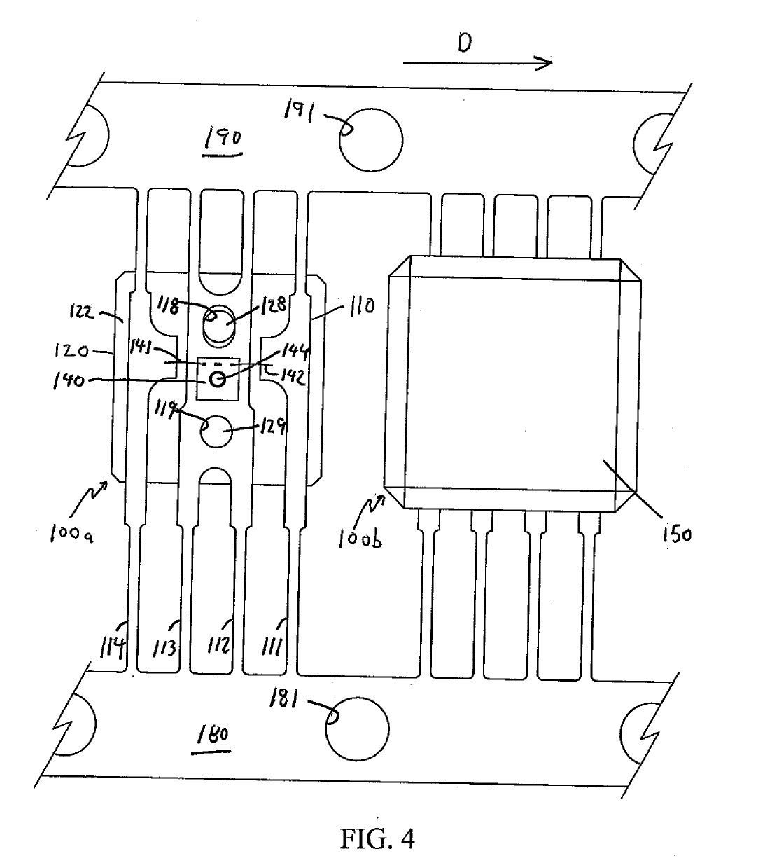

As stated above, the lead frame 110 is integrally attached to the acoustic horn 120. For example, in an embodiment, the lead frame 110 includes one or more attachment ports, indicated by representative ports 118 and 119, which align with corresponding projections 128 and 129 from an adjacent or top surface of the base portion 122 in order to knit together and integrally attach the lead frame 110 and the acoustic horn 120. The ports 118/119 and corresponding projections 128/129 may be substantially circular in shape, as shown for example in FIG. 4 (discussed below), although other numbers and shapes of ports and projections may be included without departing from the scope of the present teachings. Further, in various embodiments, the lead frame 110 and the plastic acoustic horn 120 may be integrally attached using additional or alternative means, such as adhesive bonding, for example.

The lead frame package 100 further includes a transducer die 140 attached to a second side (e.g., top side) 117 of the lead frame 110, and a cap or lid 150 that is connectable to the integrated assembly of the lead frame 110 and the acoustic horn 120. For example, the lid 150 may be press fitted to the corresponding edges of the base portion 122 of the acoustic horn 120. Also, an adhesive epoxy, for example, may be applied to a seam between the lid 150 and the corresponding edges of the base portion 122, in order to attach and/or hermetically seal the lid 150 and the integrated assembly of the lead frame 110 and the acoustic horn 120. Other attachment and/or sealing means may be incorporated without departing from the scope of the present teachings. The lid 150 may also be formed to include slots (not shown) corresponding to the terminal leads of the lead frame 110, of which only terminal lead 111 is shown in FIG. 1, enabling the terminal leads to extend from the lead frame package 100 to be connected to external circuits, for example.

In an embodiment, the lid 150 defines a cavity 155 between an inner surface 153 of the lid 150 and the second side 117 of the lead frame 110 and/or the base portion 122 of the acoustic horn 120. The transducer die 140 may be attached to the lead frame 110 using an attach material, such as a non-conductive adhesive epoxy, within the cavity 155 defined by the lid 150. The transducer die 140 is configured to convert between electrical energy and the acoustic signals (e.g., ultrasonic acoustic signals). The acoustic horn 120 provides better impedance matching, acoustic amplification and/or radiation pattern control than the transducer die 140 alone, in transmit and/or receive modes. For example, a large transducer die 140 typically has a relatively narrow beam angle, while a small transducer die 140 typically has a relatively wide beam angle. The size and shape of the acoustic horn 120 is able to manipulate these beam angles into desired patterns or beam shapes. In addition, the acoustic horn 120 is able to improve mismatches between the transducer die 140 and the propagation medium (e.g., air).

In an embodiment, the transducer die 140 includes an acoustic transducer having a suspended portion or membrane 141. The membrane 141 exposed to the exterior through back-etched portion 145 of the semiconductor chip and an aperture 116 in the lead frame 110, which are substantially aligned with the throat 126 of the acoustic horn 120. The back-etched portion 145 may be formed in a substrate, which may include various types of materials, such as glass, sapphire, alumina, or the like, or any semiconductor material, such as silicon, gallium arsenide (GaAs), indium phosphide (InP), or the like, by machining or by chemically etching the substrate using photolithography, although various alternative techniques may be incorporated. In an embodiment, by being formed on the bottom of the lead frame 110, the acoustic horn 120 provides low acoustic loss based on the inverted mounting of the transducer die 140 through the back-etched portion 145 and the aperture 116.

As stated above, the acoustic transducer may be a MEMS transducer, for example, for converting electronic signals to acoustic signals (e.g., ultrasonic signals) and/or for converting acoustic signals to electronic signals. In an embodiment, the acoustic transducer may be a thin film piezoelectric device and may include a stacked structure of a bottom electrode, a piezoelectric film, and a top electrode. The piezoelectric film can be formed from a material, such as aluminum nitride, lead zirconate titanate (PZT), or other film compatible with semiconductor processes. In another embodiment, acoustic transducer may include a piezoelectric crystal. The bottom and top electrodes may be formed from a metal compatible with semiconductor processes, such as molybdenum, tungsten, aluminum or a combination thereof.

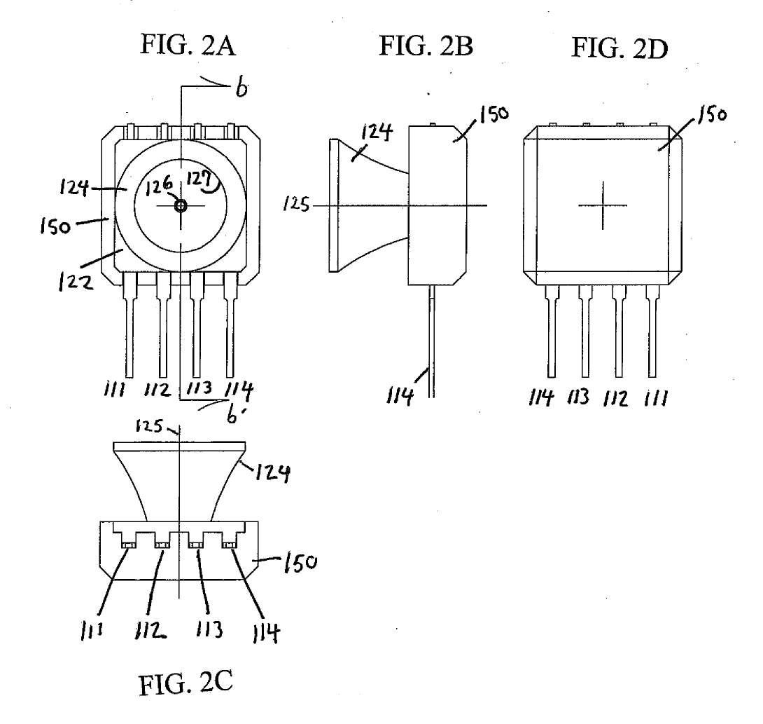

The lead frame 110 is formed from an electrically conductive material, such as various metals and metal alloys, including copper, nickel, aluminum, brass, copper/zinc alloys, and the like, or a combination thereof, for example. The material may be etched to form separate conductors and terminal leads 111-114 (e.g., shown in FIG. 2A), as well as other features, such as ports 116 and 118. The acoustic horn 120 is formed from a non-conductive material, such as various plastics or polymers, including liquid crystal polymer (LCP), polybutylene terephthalate (PBT), polypropylene (PP), polyphthalamide (PPA), and the like, for example. The acoustic horn 120 may be molded in the shape depicted, for example, in FIG. 1, using transfer molding or other molding techniques, to support different environmental and operating conditions.

In an embodiment, a protective mesh or barrier screen 121 covers the mouth 127 of the acoustic horn 120. The screen 121 includes a pattern of apertures (not shown) for communicating acoustic signals between the acoustic transducer of transducer die 140 and the exterior of lead frame package 100. For example, each of the apertures of the screen 121 may be substantially smaller than the size of aperture 116 in the lead frame 110. The screen 121 may include acoustically transparent solid material to allow acoustic signals to exit and/or enter the aperture 116, but limiting debris, contaminates and/or moisture that can enter the aperture 116. In an embodiment, the screen 121 is positioned directly in the mouth 127 of the protruding portion 124. The screen 121 may be applied after assembling the lead frame package 100, including attachment of the lid 150.

FIGS. 2A through 2D are perspective views illustrating integrated lead frame and acoustic horn packaging, according to a representative embodiment.

FIG. 2A, in particular, is a bottom perspective view of the lead frame package 100, looking into the mouth 127 of the acoustic horn 120 defined by the outer edge of the protruding portion 124, according to a representative embodiment. As discussed above, in the depicted embodiment, the protruding portion 124 has a widening cross-sectional shape, which may include substantially conical, exponential, hyperbolic shapes, for example, with a circular mouth 127 and a smaller circular throat 126, which is shown symmetrically centered within the wider diameter mouth 127. The membrane 141 (not shown) of the transducer die 140 is positioned at the throat 126.

Corner portions of the base portion 122 of the acoustic horn 120 are shown beneath the protruding portion 124, where the base portion 122 is substantially square in shape. Bottom edges of the lid 150 (in the attached position) are shown surrounding the outer periphery of the base portion 122. The terminal leads 111-114 of the lead frame 110 extend from the combined acoustic horn 120 and lid 150. However, the sizes and shapes of the protruding portion 124, the base portion 122 and the lid 150 may vary to provide unique benefits for any particular situation or to meet application specific design requirements of various implementations, as would be apparent to one skilled in the art.

FIG. 2B is a side perspective view of the lead frame package 100, taken along line b-b′ of FIG. 2A, according to a representative embodiment. FIG. 2B shows the protruding portion 124 extending from the lid 150 centered on axis 125. Only terminal lead 114 of the lead frame 110 is visible from the present perspective. FIG. 2C is another side perspective view of the lead frame package 100, according to a representative embodiment. FIG. 2C also shows the protruding portion 124 extending from the lid 150 centered on axis 125. The outer ends of the terminal leads 111-114 of the lead frame 110 are visible from the present perspective where they pass through the pre-formed slots of the lid 150.

FIG. 2D is a top perspective view of the lead frame package 100, according to a representative embodiment. FIG. 2D shows the top of the lid 150 in its attached position to the integrated assembly of the lead frame 110 and the acoustic horn 120, forming a cavity to house for the transducer 140 (not shown in FIG. 2D). The terminal leads 111-114 of the lead frame 110 extend from the cap 150 through the corresponding pre-formed slots from the present perspective.

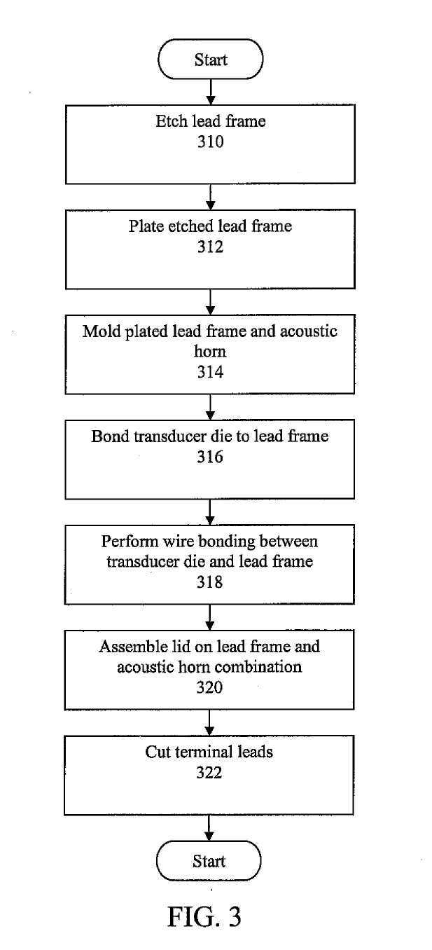

FIG. 3 is a flow diagram illustrating a process for fabricating an integrated lead and acoustic horn package, according to a representative embodiment. The depicted embodiment incorporates a reel-to-reel process, as an example, in which a string of lead frame packages are fabricated according to the various process steps and then separated into individual packaged units. It is understood, however, that other types of fabrication processes may be incorporated without departing from the scope of the present teachings.

For example, FIG. 4 is a top perspective view illustrating integrated lead and acoustic horn packaging during a reel-to-reel fabrication process, according to a representative embodiment, in which a string of lead frame packages, e.g., representative lead frame packages 100a and 100b, are still connected to reel-to-reel, lead frame alignment tracks 180 and 190. The lead frame packages 100a and 100b are in different stages of fabrication, where lead frame package 100a is shown before attachment of the lid 150 and lead frame package 100b is shown after attachment of the lid 150. The lead frame material (discussed below) includes the lead frame alignment tracks 180 and 190, which have representative guide holes 181 and 191, respectively. The guide holes 181 and 191, along with other evenly spaced guide holes, are physically engaged by revolving reels to methodically advance the lead frame alignment tracks 180 and 190 (and thus the frame packages 100a and 100b) in the direction indicated by arrow D in the course of the reel-to-reel fabrication process. Accordingly, each of the frame packages 110a and 110b is fabricated in consecutive process steps, discussed below with reference to FIG. 3, as the lead frame alignment tracks 180 and 190 advance.

Referring to FIG. 3, the lead frame is first etched in block 310 to provide a desired pattern of conductors, terminal leads and other features. The etching may include chemical etching using photolithography, for example, although various alternative techniques may be incorporated. Referring to FIG. 4, the terminal leads 111-114, as well as the depicted illustrative conductor pattern and ports 118/119, are formed during the etching process. In addition, aperture 116 (not shown in FIG. 4) is formed during the etching process in the vicinity of where the transducer die 140 is to be bonded to the lead frame 110. In block 312, the etched lead frame is plated for wirebonding, for example, using an optimized plating material, such as nickel and/or gold, to permit gold or aluminum wirebond attachment. The wirebonds provide the electrical interconnections from the MEMS to the lead frame package.

A molding operation is performed on the plated lead frame in block 314. The molding operation includes placing the plated lead frame 110 in a transfer mold previously formed to define the shape of the acoustic horn 120, including corresponding base and protruding portions 122 and 124. A polymer, e.g., LCP, PBT, PP, or PPA, is then transfer molded, for example, to encapsulate the plated lead frame 110 and to simultaneously form the acoustic horn 120. The polymer is typically a solid at room temperature, and melted prior to transfer to the mold. The shape of the acoustic horn 120 is defined by the shape of the machined transfer mold. The cooled (after melting) mold plastic will assume the horn shape within the transfer mold. Accordingly, the plastic acoustic horn 120, e.g., as shown in FIG. 1, is integrally formed to surround the lead frame 110 during the molding operation. Referring to FIG. 4, the top surface of the base portion 122 of the acoustic horn 120 is visible, while the protruding portion 124 (not shown) protrudes from the bottom side of the base portion 122. The projections 128 and 129 pass through the corresponding ports 118 and 119, which align and physically attach the acoustic horn 120 with the lead frame 110.

In block 316, the transducer die 140 is attached to the lead frame 110, e.g., on a previously formed die pad (not shown). Other components may be attached to the lead frame 110 in block 316, as well. The transducer die 140 may be attached using various techniques, such as adhesive bonding, soldering, ultrasonic welding, and the like. Wirebonding is performed in block 318, where representative bonding wires 141 and 144 are connected between pads (not shown) on the transducer die 140 and the conductor pattern (e.g., connected to lead terminals 111 and 114, respectively) of the lead frame 110. The pads on the transducer die 140 may be top pads, for example, electrically connected to the top electrodes of the acoustic transducer of the transducer die 140. In an embodiment, the transducer die 140 is previously fabricated for attachment to the lead frame 110, including etching of the back-etched portion 145, discussed above with reference to FIG. 1.

The lid 150 is attached to the combined lead frame 110 and acoustic horn 120 in block 320. The lid 150 is previously formed, for example, using a molding process similar to the transfer molding process of the acoustic horn 120, described above with reference to block 314. As shown in FIG. 4 with respect to lead frame package 100b, the lid 150 fits over the lead frame 110 and the acoustic horn 120, forming an encasement containing the transducer die 140. The terminal leads 111-114 extend from the encasement to enable electrical contact with external circuits. In an embodiment, the lid 150 is mechanically attached to the base portion 122 of the acoustic horn 120 by press fitting, for example. Alternatively or in addition, the lid 150 may be attached to the base portion 122 using an epoxy adhesive, for example, creating a hermetically sealed environment. Of course, other means of attachment, such as soldering, clamping, and the like, may be incorporated without departing from the scope of the present teachings.

In block 322, the terminal leads 111-114 are cut (and trimmed), removing the corresponding lead frame package, e.g., lead frame packages 100a and 100b, from the lead frame alignment tracks 180 and 190. The separate lead frame packages may then be subject to post fabrication processes, such as quality, electrical and/or acoustical testing and packing for shipment, for example.

Accordingly, various embodiments provide assembled lead frame packages that include encased transducer dies, such as MEMS transducers, and integrated acoustic horns. The acoustic horns may have any of a variety of shapes, used for amplifying acoustic signals, forming/shaping an acoustic beam of the acoustic signals and/or providing impedance matching in accordance with application specific design requirements of various implementations, as would be apparent to one skilled in the art.

The various components, materials, structures and parameters are included by way of illustration and example only and not in any limiting sense. In view of this disclosure, those skilled in the art can implement the present teachings in determining their own applications and needed components, materials, structures and equipment to implement these applications, while remaining within the scope of the appended claims.

1. A device for manipulating acoustic signals, the device comprising:
a transducer die attached to a lead frame and configured to convert between electrical energy and the acoustic signals, the transducer die comprising a transducer membrane; and
a horn integrally connected with the lead frame, the horn extending from the lead frame and comprising a throat positioned adjacent to the transducer membrane and a mouth opening at an opposite end of the horn from the throat.

2. The device of claim 1, wherein the transducer die comprises a micro electro-mechanical system (MEMS) transducer.

3. The device of claim 1, wherein the transducer die is attached to a top surface of the lead frame and the horn extends from a bottom surface of the lead frame, the lead frame defining an aperture between the transducer membrane and the throat of the horn.

4. The device of claim 3, further comprising:
a lid connected to the top surface of the lead frame, the lid and a base portion of the horn defining a cavity, wherein the transducer die is positioned within the cavity.

5. The device of claim 4, wherein the cavity is hermetically sealed.

6. The device of claim 1, wherein the horn comprises plastic transfer molded through a portion of the lead frame and extending from the lead frame to the mouth of the horn.

7. The device of claim 6, wherein at least a portion of a cross-section of the horn has a widening shape.

8. The device of claim 6, wherein the molded plastic comprises at least one of liquid crystal polymer (LCP), polybutylene terephthalate (PBT), polypropylene (PP), polyphthalamide (PPA).

9. The device of claim 6, wherein the lead frame defines at least one port through which the transfer molded plastic extends, knitting together the lead frame and the horn.

10. The device of claim 1, wherein the transducer die comprises at least one contact pad connected to the lead frame via at least one corresponding bonding wire.

11. The device of claim 1, further comprising:
a screen covering the mouth of the horn and configured to protect the transducer die from at least one of debris, contaminates, and moisture.

12. A device comprising:
a lead frame;
an acoustic horn comprising a base portion integrated with the lead frame and a protruding portion extending from the lead frame, the acoustic horn defining a first aperture corresponding to a horn throat and a second aperture corresponding to a horn mouth; and
an transducer die positioned on the lead frame adjacent to the first aperture of the acoustic horn, and configured to convert between electrical energy and acoustic signals, wherein the acoustic horn adjusts a radiation pattern of the acoustic signals.

13. The device of claim 12, wherein the transducer die comprises a micro electro-mechanical system (MEMS) transducer.

14. The device of claim 12, further comprising:
a lid connected to the base portion of the acoustic horn and defining a cavity between an inner surface of the lid and a top surface of the base portion, the transducer die being positioned within the cavity.

15. The device of claim 14, wherein the first aperture has a smaller diameter than the second aperture.

16. The device of claim 14, further comprising:
a screen covering the second aperture of the acoustic horn and configured to protect the transducer die from at least one of debris, contaminates and moisture.

17. A packaged semiconductor device comprising:
a lead frame defining an aperture;
a transfer molded acoustic horn comprising a base portion integrated with the lead frame and a protruding portion extending from the lead frame, a throat of the acoustic horn being substantially aligned with the aperture of the lead frame;
a lid connected to the integrated acoustic horn and lead frame to form a cavity; and
a transducer die positioned in the cavity on the lead frame, the transducer die comprising a micro electro-mechanical system (MEMS) transducer configured to convert between electrical energy and acoustic signals, the MEMS transducer having a membrane and a back-etched portion substantially aligned with the aperture of the lead frame and the throat of the acoustic horn.

18. The device of claim 17, wherein the acoustic horn adjusts a radiation pattern of the acoustic signals.

19. The device of claim 17, wherein the acoustic horn provides impedance matching for the acoustic signals.

20. The device of claim 17, further comprising:
a screen covering a mouth of the acoustic horn, opposite the throat of the acoustic horn, the screen protecting the transducer die from at least one of debris, contaminates and moisture.
